(19) United States
(12) Patent Application Publication
(10) Pub. No.: US 2021/0150459 A1
(43) Pub. Date: May 20, 2021

(54) INVENTORY TRACKING SYSTEM

(71) Applicant: Sato Holdings Kabushiki Kaisha, Tokyo (JP)

(72) Inventor: Graham Murdoch, St. Peters (AU)

(73) Assignee: Sato Holdings Kabushiki Kaisha, Tokyo (JP)

(21) Appl. No.: 16/492,748

(22) PCT Filed: Mar. 9, 2018
(86) PCT No.: PCT/IB2018/051534

§ 371 Date: Sep. 10, 2019

(30) Foreign Application Priority Data
Mar. 10, 2017 (AU) 2017900839

(51) Int. Cl. G06Q 10/08; G06K 7/10

(52) U.S. Cl. CPC G06Q 10/087; G06K 7/10475; G06K 7/10316

(57) ABSTRACT

Described is a receptacle comprising a structure defining a volume. The receptacle comprises at least one shelf for holding electronically labelled items, the shelf being arranged within the volume of the structure. The receptacle also comprises at least one antenna associated with the at least one shelf, and a flexible electromagnetic shield associated with the structure and configured to inhibit electromagnetic interference at the at least one antenna.

### TECHNICAL FIELD

The present disclosure relates, generally, to inventory tracking and, more particularly, to receptacles or containers used for radio frequency inventory tracking.

### BACKGROUND

Conventionally, tracking the inventory of items stored in a cupboard or on a shelf typically comprises manually checking each item, for example by unpacking the cupboard or shelf. To restock used items, remaining items are checked against a list of required items and then supplemented. In the case of medical transportation trolleys, for example as used in operating theatres to store surgical items, following surgery the trolleys are typically unpacked and repacked to ensure that all required items are present for a following use.

One way to facilitate inventory tracking and restocking is to attach electronic tags to items that can be read by an electronic reader, for example RFID tags that can be read by an RFID reader. RFID enabled containers or cupboards, however, can be costly.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

RFID enabled containers tend to be costly not only due to the electronics required on the receptacle (for example the antennas in the body and/or shelving of the receptacle, as well as the reader that processes the antenna signals), but also due to the metal walls and doors required to provide electromagnetic shielding for the electronics. Electromagnetic shielding is used so that interfering signals do not compromise the accuracy of the readings provided by the RFID reader.

Accordingly, in one aspect there is provided a receptacle comprising: a structure defining a volume; at least one shelf for holding electronically labelled items, the shelf being arranged within the volume of the structure; at least one antenna associated with the at least one shelf; and a flexible electromagnetic shield associated with the structure and configured to inhibit electromagnetic interference at the at least one antenna.

The structure may comprise a frame that supports the at least one shelf.

The electromagnetic shield may comprise a flexible metallic fabric. The flexible metallic fabric may comprise a material selected from the group consisting of: metal woven mesh, metal film, metal coated fibres, silver coated nylon, silver coated rayon, copper coated nylon, and combinations of thereof. The electromagnetic shield may form part of a dust cover. The dust cover may enshroud the structure. The dust cover may define an access opening to gain access to the volume of the structure, the access opening being closed by a displaceable panel of the dust cover. The displaceable panel may be conductively fastened to adjacent panels of the dust cover when in a closed position.

The at least one antenna may comprise two or more independent antenna coils. The receptacle may then further comprise a first multiplexer that interfaces with the two or more antenna coils. The receptacle may also comprise at least two shelves; at least one antenna associated with each shelf; and an antenna interface configured to interface with an electronic reader via a second multiplexer that sequentially interrogates the antennas via the antenna interface. The receptacle may also comprise the second multiplexer. The antenna interface may be configured: to receive a read signal from the electronic reader when the antenna interface is in communication with the electronic reader, and to provide the read signal to each antenna so that the electronically labelled items on the shelf associated with that antenna are read for identification.

The receptacle may further comprise the electronic reader.

The receptacle may further comprise a power interface for receiving power from an external power supply when the electronically labelled items are read for identification.

The structure may be a mobile structure. The structure may be mounted on a wheeled base.

In another aspect there is provided an inventory tracking system comprising: a mobile receptacle for holding electronically labelled items, the mobile receptacle having at least one antenna for interrogating the electronically labelled items; a flexible electromagnetic shield configured to be positioned about at least part of the at least one antenna and configured to inhibit electromagnetic interference at the at least one antenna; and an electronic reader in communication with the at least one antenna and configured to identify electronically labelled items interrogated by the at least one antenna.

The flexible electromagnetic shield may be at least one of separate and removable from at least one of the receptacle and the reader.

In another aspect there is provided an inventory tracking system comprising: a mobile receptacle comprising: a structure defining a volume; at least one shelf for holding electronically labelled items, the shelf being arranged within the volume of the structure; at least one antenna associated with the at least one shelf; a flexible electromagnetic shield associated with the structure and configured to inhibit electromagnetic interference at the at least one antenna; and a first electrical interface; and a docking station comprising: a second electrical interface for interfacing with the first electrical interface; an electronic reader configured to receive read signals from the at least one antenna; and a power source for providing power to at least the mobile receptacle. The docking station may include an antenna multiplexer.

In another aspect there is provided an inventory tracking system comprising: a mobile receptacle comprising: a structure defining a volume; and at least one shelf for holding electronically labelled items, the shelf being arranged within the volume of the structure; a docking station comprising: at least one antenna associated with the at least one shelf; an electronic reader configured to receive read signals from the at least one antenna; and a power source for providing power to at least the docking station; and a flexible electromagnetic shield configured to be positioned so as to inhibit electromagnetic interference at the at least one antenna. The docking station may include an antenna multiplexer.

In another aspect there is provided a method of inventory tracking, the method comprising: providing a mobile receptacle for holding electronically labelled items, the mobile receptacle containing at least one antenna; positioning a flexible electromagnetic shield around at least part of the mobile receptacle and the at least one antenna, and then: activating the at least one antenna to interrogate the electronically labelled items to generate an antenna signal; providing the antenna signal to an electronic reader; and reading the antenna signal to determine an inventory of the mobile receptacle.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure are now described by way of example with reference to the accompanying drawings in which:—

FIG. 1 is a perspective view of an embodiment of a receptacle;

FIG. 2 is a schematic representation of an embodiment of an inventory tracking system; and

FIG. 3 is a diagram of a method of inventory tracking.

In the drawings, like reference numerals designate similar parts.

### DESCRIPTION OF EMBODIMENTS

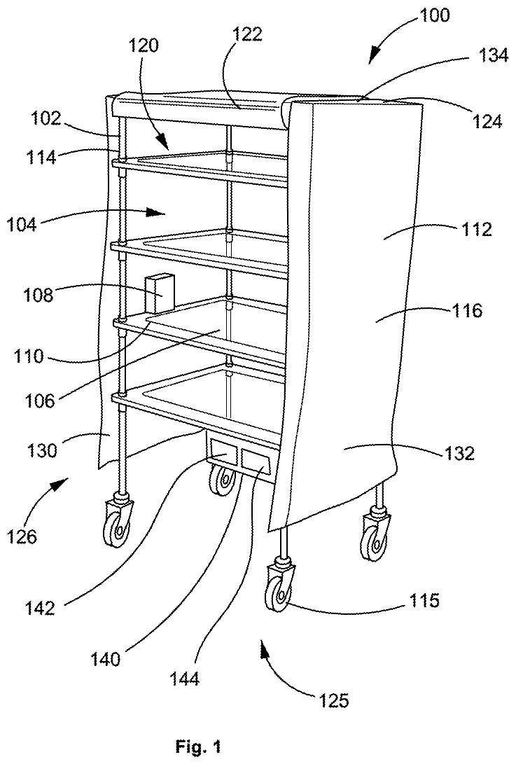

FIG. 1 of the drawings shows an embodiment of a receptacle 100 that has a structure 102 defining a volume 104. At least one shelf 106 for holding electronically labelled items 108 is arranged within the volume 104 of the structure 102. At least one antenna 110 is associated with the shelf 106. The receptacle 100 has a flexible electromagnetic shield 112 that is associated with the structure 102, and that is configured to inhibit electromagnetic interference at the, or each, antenna 110.

In the embodiment shown in FIG. 1, the receptacle 100 is in the form of a mobile trolley. However, as used herein the term “receptacle” is understood to mean any type of trolley, shelf, cabinet, table, container, repository or other structure that has one or more surfaces, areas or zones that can carry, hold, support, store or otherwise receive a labelled item. The structure 102 has a frame 114 which may be made of a conductive or non-conductive material. The frame 114 includes a wheeled base, and the wheels may be, for example, castors 115.

Suspended from a floor 125 of the frame 114 is a processing unit 140 that includes an electronic reader 142 in communication with the at least one antenna 110. For embodiments that include multiple antennas (for example in a trolley 100 that includes multiple shelves, as shown in FIG. 1), the processing unit 140 also includes a multiplexer 144. The multiplexer 144 multiplexes signals to and from the antennas 110 when the antennas 110 for the shelves 106 are individually activated during inventory checking.

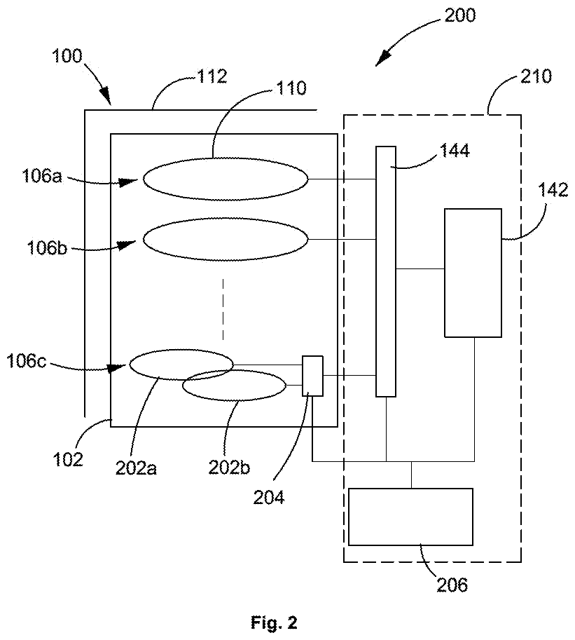

In other embodiments, the processing unit 140 or the electronic reader 142 may be separate from the trolley 100. In such embodiments, the processing unit 140 or electronic reader 142 may be provided at a docking station used when inventory is checked (see the description elsewhere herein with reference to FIG. 2). In some embodiments one processing unit 140, electronic reader 142, or docking station may be used to check the inventory of more than one trolley 100. This may be done concurrently or one after the other, depending on the specific configuration of the inventory tracking system, as described in more detail elsewhere herein with reference to FIG. 2.

The flexible electromagnetic shield 112 in the embodiment shown in FIG. 1 forms part of a dust cover 116. The shield 112 is made at least in part from a flexible, metallic or metal coated fabric, for example metal woven mesh, metal film, metal coated fibres, silver coated nylon, silver coated rayon, copper coated nylon, or the like. The dust cover 116 has panels providing shielding on at least two sides of the trolley 100, but typically providing shielding on all four sides and over a roof or top 124 of the trolley 100. In some embodiments the dust cover 116 can also provide shielding under the floor 125 of the trolley 100. The dust cover 116 also includes an access opening openable on one or more sides of the dust cover 116. In this example the access opening 120 is provided by a door panel 122 in the form of a flap. In FIG. 1 the door panel 122 is shown open at a front 126 of the trolley 100, and is folded back over the roof 124 of the trolley 100. In the closed position, the door panel 122 is fastened to adjacent panels 130, 132 on the left and right respectively, and fastened or continuous with the roof panel 134 to ensure a substantially continuous screening effect.

In some embodiments, fastening of the panels, such as the door panel 122, is done using conductive fasteners, such as metal clasps or zippers (not shown). This is done in such a way that only small openings or slits remain in the shield 112 when the shield 112 is closed. For long wavelength systems as used with RFID technology, small slits between panels are typically 10 cm, or shorter, so as to avoid excessive nearfield emission.

In the embodiment shown in FIG. 1, the shield 112 hangs over the frame 114, shielding the four sides of the frame 114 and the roof 124. The shield 112 may be attached to the frame, forming part of the receptacle. Where the frame 114 is conductive, the shield 112 may be connected at one or more contact points to the frame 114. This may provide some advantage in shield operation.

In this embodiment, the dust cover 116 is also removable, and can be lifted off of the trolley completely when not required. In other embodiments, the shield 112 may be provided separately from the frame 114, for example in the form of a detachable curtain that can be attached to the structure on one or more sides. In still other embodiments, the shield 112 may be provided in the form of a separate curtain, for example suspended from a curtain rail so that when the receptacle is positioned at the curtain rail, the separate curtain comprising the shield may be drawn around two or more sides of the receptacle.

The shield 112 is used to provide electromagnetic shielding while the antennas 110 are operating. Electromagnetic shielding is essential to the operation of the electronics so that external interference signals do not compromise the accuracy of the readings provided by the RFID reader. Electromagnetic shielding is also required to avoid both co-interference (i.e. crosstalk that can result from an antenna in a different receptacle operating at the same frequency) as well as cross-reading (i.e. an antenna reading an electronic tag present in another receptacle).

FIG. 2 of the drawings shows a schematic representation of an embodiment of an inventory tracking system 200. The system 200 includes a trolley 100, for example as described with reference to FIG. 1, and a docking station 210 which is able to be communicatively coupled to the trolley 100 for inventory tracking. As illustrated, the trolley 100 has multiple shelves 106a, 106b, 106c, each with its own antenna 110. Some of the shelves 106a, 106b, 106c may include more than one antenna as shown for shelf 106c where antenna coil 202a and antenna coil 202b are provided, for example in order to cover a larger area and/or to provide two or three dimensional operation about the shelf 106c. Where more than one antenna coil is provided on a shelf, a first multiplexer 204 is provided per shelf to multiplex between the antenna coils on that shelf. The first multiplexer 204 typically forms part of the antenna combination on the shelf, so that the multiplexer 204 would be provided as part of the trolley 100. A second multiplexer 144 is used to multiplex the antenna signals received from the different shelves 106. In the embodiment illustrated in FIG. 2, the second multiplexer is separate from the trolley 100 and forms part of the docking station 210. This is in contrast to the embodiment illustrated in FIG. 1, where the multiplexer 144 is carried on the trolley 100.

In this embodiment, the trolley 100 has an antenna interface (not shown) that is configured to interface with the electronic reader 142 via the second multiplexer 144. The second multiplexer 114 sequentially interrogates the antennas 110 via the antenna interface.

In some embodiments, the antenna interface is configured to receive a read signal from the electronic reader 142 when the antenna interface is in communication with the electronic reader 142, and to provide a read signal to each antenna 110 so that the electronically labelled items 108 are read by the relevant antenna 110 for identification.

As shown in FIG. 2, the docking station 210 also includes the electronic reader 142 as well as a power supply 206 that provides power to the trolley 100 and one or more parts of the docking station 210.

In some embodiments, the antennas 110 and/or coils 202a, 202b are part of the docking station 210. In such embodiments, the trolley 100 may or may not include any antennas. When the trolley 100 is docked at the docking station the antennas 110 and/or coils 202a, 202b are positioned in, beside, around or otherwise proximate the trolley and/or trolley shelves so that the tagged items 108 on the trolley shelves are within a reading range of the antennas 110 and/or coils 202a, 202b. The coils 202a, 202b are connected to a first multiplexer 204, and the antenna 110 and first multiplexer 204 are connected to a second multiplexer 144. The second multiplexer 144 sequentially interrogates the antenna 110 and first multiplexer 204. The second multiplexer 144 communicates with the electronic reader 142. The docking station 210 also includes a power supply 206 that provides power to the one or more parts of the docking station 210.

In embodiments where the shield 112 is provided in the form of a separate curtain, the shield 112 may be part of or be associated with the docking station instead of with the trolley 100. One example is the provision of a docking station within an electromagnetic shield (such as a flexible curtain, a flexible dust cover, or a metal-walled cubicle) so that the trolley 100 is shielded when positioned at the docking station and within the electromagnetic shield. In some embodiments, the electromagnetic shield may be configured to include multiple compartments so that a receptacle may be positioned in each of the separate compartments of a compartmentalised electromagnetic shield. Each compartment may include its own docking station. Additionally or alternatively the compartments may share a docking station, with each receptacle in a separate compartment checked for inventory one at a time by the same docking station. In some embodiments, the docking station may include more than one electronic reader so that the docking station is configured to receive and check the inventory of more than one trolley at a time.

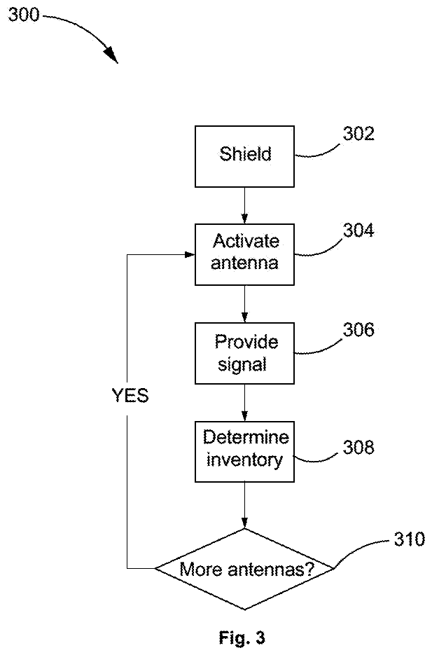

FIG. 3 illustrates diagrammatically a method 300 of inventory tracking. At 302 a flexible electromagnetic shield 112 is positioned around at least part of the trolley 100 with the at least one antenna 106. When the shield 112 is in position, at 304 an antenna 106 is activated to interrogate the electronically labelled items 108 on a shelf 106 of the trolley 100, generating an antenna signal.

At 306 the antenna signal is provided to the electronic reader 142, and at 308 the antenna signal is read to determine the inventory of that shelf 106 of the trolley 100 associated with the antenna 110. In embodiments where multiple antennas are used, at 310 one or more antenna multiplexers are used so that one antenna signal is read at a time, thereby generating a series of antenna signals from the antennas, the series of antenna signals then being provided to the electronic reader 142.

Using a flexible electromagnetic shield as described herein enables the use of a low cost receptacle while still providing the electromagnetic shielding required to avoid both co-interference as well as cross-reading.

The use of a docking station further contributes to lowering the cost of the receptacles used as resources are shared amongst multiple receptacles. Some of the hardware required for inventory tracking (such as the electronic reader, antenna multiplexer, antenna or antenna components, and/or power supply) can be centralised and shared for multiple receptacles. In some embodiments, a separate electromagnetic shield provided, for example, as a suspended curtain or metal-walled cubicle at the docking station may further reduce the cost of the receptacles.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A receptacle comprising:
a structure defining a volume;
at least one shelf for holding electronically labelled items, the shelf being arranged within the volume of the structure;
at least one antenna associated with the at least one shelf; and
a flexible electromagnetic shield associated with the structure and configured to inhibit electromagnetic interference at the at least one antenna, wherein the electromagnetic shield enshrouds the structure.

2. The receptacle of claim 1, in which the structure comprises a frame that supports the at least one shelf.

3. The receptacle of claim 1, wherein the electromagnetic shield comprises a flexible metallic fabric.

4. The receptacle of claim 3, wherein the flexible metallic fabric comprises a material selected from the group consisting of: metal woven mesh, metal film, metal coated fibres, silver coated nylon, silver coated rayon, copper coated nylon, and combinations of thereof.

5. The receptacle of claim 1, wherein the electromagnetic shield forms part of a dust cover.

6. (canceled)

7. The receptacle of claim 5 in which the dust cover defines an access opening to gain access to the volume of the structure, the access opening being closed by a displaceable panel of the dust cover.

8. The receptacle of claim 7, wherein the displaceable panel is conductively fastened to adjacent panels of the dust cover when in a closed position.

9. The receptacle of claim 1, wherein the at least one antenna comprises two or more independent antenna coils.

10. The receptacle of claim 9, further comprising a first multiplexer that interfaces with the two or more antenna coils.

11. The receptacle of claim 10, further comprising:
at least two shelves;
at least one antenna associated with each shelf; and
an antenna interface configured to interface with an electronic reader via a second multiplexer that sequentially interrogates the antennas via the antenna interface.

12. The receptacle of claim 11, further comprising the second multiplexer.

13. The receptacle of claim 11, wherein the antenna interface is configured:
to receive a read signal from the electronic reader when the antenna interface is in communication with the electronic reader, and
to provide the read signal to each antenna so that the electronically labelled items on the shelf associated with that antenna are read for identification.

14. The receptacle of claim 11, further comprising the electronic reader.

15. The receptacle of claim 1 further comprising a power interface for receiving power from an external power supply when the electronically labelled items are read for identification.

16. The receptacle of claim 1 wherein the structure is a mobile structure.

17. The receptacle of claim 16, wherein the structure is mounted on a wheeled base.

18.-19. (canceled)

20. An inventory tracking system comprising:
a mobile receptacle comprising:
a structure defining a volume;
at least one shelf for holding electronically labelled items, the shelf being arranged within the volume of the structure;
at least one antenna associated with the at least one shelf;
a flexible electromagnetic shield associated with the structure and configured to inhibit electromagnetic interference at the at least one antenna, wherein the electromagnetic shield enshrouds the structure; and
a first electrical interface; and
a docking station comprising:
a second electrical interface for interfacing with the first electrical interface;
an electronic reader configured to receive read signals from the at least one antenna; and
a power source for providing power to at least the mobile receptacle.

21. (canceled)

22. A method of inventory tracking, the method comprising:
providing a mobile receptacle for holding electronically labelled items, the mobile receptacle containing at least one antenna;
positioning a flexible electromagnetic shield to enshroud the mobile receptacle and the at least one antenna, and then:
activating the at least one antenna to interrogate the electronically labelled items to generate an antenna signal;
providing the antenna signal to an electronic reader; and
reading the antenna signal to determine an inventory of the mobile receptacle.
